(19) United States
(12) Patent Application Publication
(10) Pub. No.: US 2007/0171786 A1
(43) Pub. Date: Jul. 26, 2007

(54) Optical pickup apparatus and optical disk apparatus

(76) Inventors: Takashi Kobayashi, Kanagawa (JP); Noriaki Nishi, Kanagawa (JP)

Correspondence Address: FROMMER LAWRENCE & HAUG LLP, 745 FIFTH AVENUE, NEW YORK, NY, 10151, US

(21) Appl. No.: 11/643,411

(22) Filed: Dec. 21, 2006

(30) Foreign Application Priority Data
Dec. 26, 2005 (JP) 2005-372729

(51) Int. Cl. G11B 7/00

(52) U.S. Cl. 369/44.37; 369/112.01; 369/44.23

(57) ABSTRACT

An optical pickup includes: a light source for an optical disk; a beam splitter for splitting into a main and sub beams; and a photo-detector for sensing the main and sub beams reflected from the disk and outputting a signal corresponding to the sensed beams; wherein the splitter generates two sub beams by deflecting a portion of the light traveling toward an outside of an aperture of an objective lens so as to provide passage through an inside of the aperture of the lens, while generating the main beam based on the other portion of the beam from the source; and the main beam from the disk contains an area involving overlap of zero- and ±first-order light yielded by a track structure of the disk, while the two sub beams contain no area involving the overlap of the zero- and the ±first-order light yielded by the track structure.

### BACKGROUND OF THE INVENTION

1. Field of the Invention

The present invention relates to an optical pickup apparatus and an optical disk apparatus, and more particularly, to an optical pickup apparatus and an optical disk apparatus that permit stabled servo control to be obtained with a simple configuration.

2. Description of Related Arts

In recent years, a high-density and large-capacity optical disk such as a DVD (Digital Versatile Disc) has been put to practical use as a high-density and large-capacity storage medium, and is widespread as an information medium effective in handling a mass of information like a moving image.

Usually, an optical pickup in an optical disk apparatus for providing recording or reading etc. of information for the optical disk emits a light beam to the optical disk, senses the beam reflected from an information recording surface of the optical disk with a photo-detecting unit having more than one divided area, and detects a tracking error signal using a method such as a push-pull method based on a signal outputted from the photo-detecting unit in response to light sensed in each area.

However, with the push-pull method carried out using only a single beam, an impact of lens shift sometimes leads to a development of a tracking error.

Accordingly, one technology of reducing an error of the tracking error signal has been proposed. According to a so-called differential push-pull method, for instance, with a main beam arranged in displacement from two sub beams by a preset distance in a direction orthogonal to tracks, the tracking error signal obtained from the main beam and that obtained from the two sub beams are respectively assumed to be a first push-pull signal and a second push-pull signal, whereby a differential operation of the first and the second push-pull signals allows the tracking error signal to be obtained.

That is, with the differential push-pull method, the impact of the lens shift is canceled, enabling detection of a substantially error-free tracking error signal.

There has been also proposed one technology of correcting the impact of the lens shift by extracting a push-pull component-free area contained in the main beam (See Patent document 1, for instance). [Patent document 1] Japanese Patent Application Publication No. 2004-281026

However, with the differential push-pull method, the main and the sub beams are generated using a grating, so that a reduction in light utilization occurs, leading to needs for increasing an intensity of the beam emitted from a light source, and hence, for modifying an apparatus configuration.

Further, with the differential push-pull method, the sub beams also contain an AC (or push-pull) component, so that lens shift detection requires that a sub beam position be adjusted to obtain an inverse phase of a push-pull signal of each sub beam with respect to the main beam. Further, spacing between the main beam and each sub beam is unallowable to be largely increased in order to avoid a phase shift of the push-pull component in each sub beam in a range from an inside to an outside of the disk. Thus, when recording or reading the information into or from a multi-layered recording medium (or the optical disk), for instance, a possibility exists that stray light from a different layer causes degradations of tracking error signal characteristics.

Even though an attempt is made to apply the technology disclosed in the above patent document 1 to extract the push-pull component-free area contained in the main beam, extraction by use of the grating presented at this side of the photo-detecting unit is significantly affected by perturbation, resulting in drastic degradations of the tracking error signal characteristics.

Further, a reduction in grating spacing is required for the grating in order to avoid the impact of the stray light from the different layer, resulting in needs for complicated and difficult works on positional adjustments etc. in manufacturing of the grating.

### SUMMARY OF THE INVENTION

The present invention has been undertaken in view of the above circumstances, and is intended to permit stabled servo control to be obtained with a simple configuration.

A first aspect of the present invention relates to an optical pickup apparatus having a light source for generating light irradiated to an optical recording medium configured as a disk; a beam splitting unit for splitting a light beam emitted from the light source into a main beam and sub beams; and a photo-detecting unit for sensing the main and the sub beams reflected from a recording surface of the recording medium, and outputting a signal corresponding to the sensed light beams, wherein the beam splitting unit generates two sub beams by deflecting a portion of the light contained in the light beam emitted from the light source traveling toward an outside of an aperture of an objective lens for converging the light beam on the recording surface of the recording medium so as to provide passage of the light through an inside of the aperture of the objective lens, while generating the main beam based on the other portion of the light beam emitted from the light source; and the main beam reflected from the recording surface of the recording medium contains an area involving overlap of zero- and ±first-order light yielded by a track structure of the disk, while the two sub beams reflected from the recording surface of the recording medium contain no area involving the overlap of the zero- and the ±first-order light yielded by the track structure of the disk.

According to the first aspect of the present invention, the beam splitting unit permits the two sub beams to be generated in such a manner that the light in the portion contained in the light beam emitted from the light source and supposed to travel toward the outside of the aperture of the objective lens for converging the light beam on the recording surface of the recording medium is deflected so as to provide the passage of the light through the inside of the aperture of the objective lens, while permitting the main beam to be generated based on the light in the other portion of the light beam emitted from the light source, and ensures that the main beam reflected from the recording surface of the recording medium contains the area involving the overlap of the zero- and the ±first-order light yielded by the track structure of the disk, while the sub beams contain no area involving the overlap of the zero- and the ±first-order light yielded by the track structure of the disk.

A second aspect of the present invention relates to an optical disk apparatus having an optical pickup unit having a light source for generating light irradiated to an optical recording medium configured as a disk, a beam splitting unit for splitting a light beam emitted from the light source into a main beam and sub beams, and a photo-detecting unit for sensing the main and the sub beams reflected from a recording surface of the recording medium, followed by outputting a signal corresponding to the sensed light beams; and a control unit for providing servo control of the optical pickup unit, wherein the beam splitting unit generates, by deflecting the light in a portion contained in the light beam emitted from the light source and supposed to travel toward an outside of an aperture of an objective lens for converging the light beam on the recording surface of the recording medium so as to provide passage of the light through an inside of the aperture of the objective lens, two sub beams of a type containing, in the sub beams reflected from the recording surface of the recording medium, no area involving overlap of zero- and ±first-order light yielded by a track structure of the disk, while generating, based on the light in the other portion of the light beam emitted from the light source, a main beam of a type containing, in the main beam reflected from the recording surface of the recording medium, an area involving the overlap of the zero- and the ±first-order light yielded by the track structure of the disk; and the control unit generates a push-pull signal from a signal specified as a signal outputted from the photo-detecting unit and corresponding to a light spot of the sensed main beam, while generating a lens shift signal from a signal specified as the signal outputted from the photo-detecting unit and corresponding to light spots of the sensed two sub beams, followed by generating a tracking error signal based on the push-pull signal and the lens shift signal.

According to the second aspect of the present invention, the beam splitting unit permits the two sub beams of the type containing, in the sub beams reflected from the recording surface of the recording medium, no area involving the overlap of the zero- and the ±first-order light yielded by the track structure of the disk to be generated in such a manner that the light in the portion contained in the light beam emitted from the light source and supposed to travel toward the outside of the aperture of the objective lens for converging the light beam on the recording surface of the recording medium is deflected so as to provide the passage of the light through the inside of the aperture of the objective lens, while permitting the main beam of the type containing, in the main beam reflected from the recording surface of the recording medium, the area involving the overlap of the zero- and the ±first-order light yielded by the track structure of the disk to be generated based on the light in the other portion of the light beam emitted from the light source. Further, the control unit permits the push-pull signal to be generated from the signal specified as the signal outputted from the photo-detecting unit and corresponding to the light spot of the sensed main beam, while permitting the lens shift signal to be generated from the signal specified as the signal outputted from the photo-detecting unit and corresponding to the light spots of the sensed two sub beams, causing the tracking error signal to be generated based on the push-pull signal and the lens shift signal.

According to the present invention, the stabled servo control may be obtained with the simple configuration.

### BRIEF DESCRIPTION OF THE DRAWINGS

The foregoing and other objects and features of the invention will become more apparent from the following description of the invention taken in conjunction with the accompany drawings, in which:

FIG. 1 is a block diagram showing one configuration according to one preferred embodiment of an optical disk apparatus involving an application of the present invention;

FIG. 2 is a block diagram showing one configuration according to one preferred embodiment of an optical pickup apparatus involving the application of the present invention;

FIG. 3 shows one configuration of a sub-beam generating grating in FIG. 2:

FIGS. 4A to 4C show one images of a main beam and sub beams generated by the sub-beam generating grating in FIG. 3:

FIGS. 5A to 5C show one configuration of a photo-sensing section of a photo-detecting unit in FIG. 2;

FIG. 6 shows one arrangement of each area of the photo-sensing section of the photo-detecting unit;

FIG. 7 shows one different configuration of the sub-beam generating grating in FIG. 2;

FIGS. 8A to 8C show one images of the main and the sub beams generated by the sub-beam generating grating in FIG. 7;

FIGS. 9A to 9C show one configuration of the photo-sensing section of the photo-detecting unit in FIG. 2;

FIG. 10 is a graphic representation of one distribution of light intensity of the main beam generated by the sub-beam generating grating in FIG. 7;

FIG. 11 shows one configuration of a sub-beam generating prism;

FIG. 12 shows one configuration of sub-beam generating mirrors;

FIG. 13 shows one configuration of sub-beam generating scattering plate;

FIG. 14 shows one configuration of sub-beam generating edges;

FIG. 15 shows one configuration of a sub-beam generating polarizing grating;

FIG. 16 shows one configuration of a polarized sub-beam generating grating;

FIG. 17 shows one different configuration of the polarized sub-beam generating grating;

FIG. 18 is a block diagram showing one different configuration of the optical pickup apparatus;

FIG. 19 is a block diagram showing one further different configuration of the optical pickup apparatus;

FIG. 20 is a block diagram showing one still further different configuration of the optical pickup apparatus;

FIG. 21 shows the photo-detecting unit in FIG. 20 as seen from its side face;

FIG. 22 shows one images of the sub beams obtained when detecting a focus error signal with the optical pickup apparatus;

FIGS. 23A to 23C show one configuration of the photo-sensing section of the photo-detecting unit adaptable to detection in the case shown in FIG. 22;

FIG. 24 shows one images of the sub beams obtained when detecting a disk tilt signal with the optical pickup apparatus; and

FIGS. 25A to 25C show one configuration of the photo-sensing section of the photo-detecting unit adaptable to detection in the case shown in FIG. 24.

### DESCRIPTION OF THE INVENTION

While embodiments of the present invention are now described, it is to be understood that the following is one illustration on a correspondence between constitutional requirements of the present invention and the embodiments contained in a present specification or drawings. This is a description to ascertain that the embodiments adapted to support the present invention are contained in the present specification or the drawings. Thus, if there is any other embodiment contained in the present specification or the drawings and not shown herein as that meeting the constitutional requirements of the present invention, it is not to be construed that this embodiment is referred to that meeting no constitutional requirements of the present invention. Conversely, if the embodiment shown herein is that meeting the constitutional requirements, it is not to be construed that this embodiment is referred to that meeting no constitutional requirements other than the above.

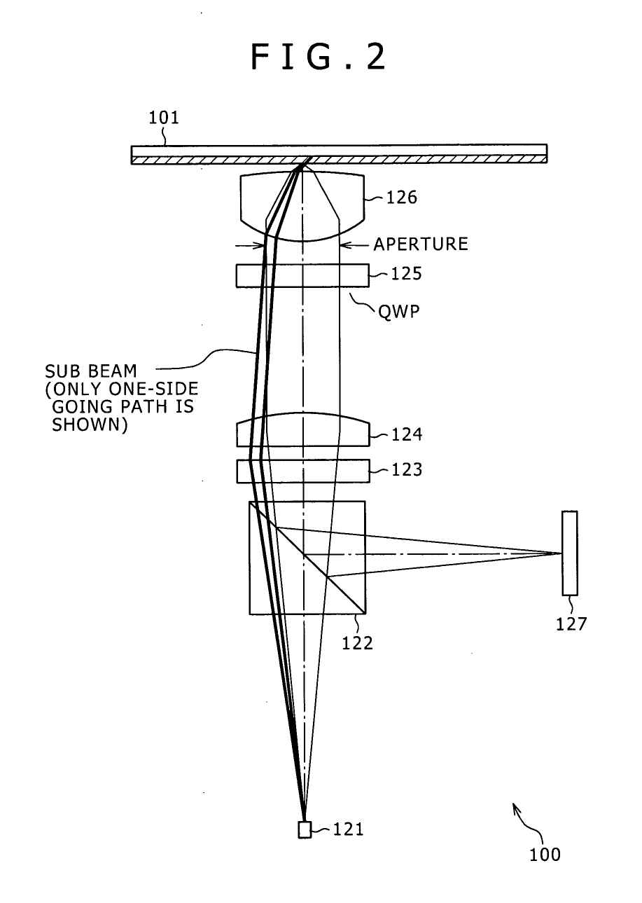

The optical pickup apparatus according to the first aspect of the present invention relates to the optical pickup apparatus having the light source (or a light source 121 in FIG. 2, for instance) for generating the light irradiated to the optical recording medium (or an optical recording medium 101 in FIG. 2, for instance) configured as the disk; the beam splitting unit (or a sub-beam generating grating 123 in FIG. 2, for instance) for splitting the light beam emitted from the light source into the main beam and the sub beams; and the photo-detecting unit (or a photo-detecting unit 127 in FIG. 2, for instance) for sensing the main and the sub beams reflected from the recording surface of the recording medium, followed by outputting the signal corresponding to the sensed light beams, wherein the beam splitting unit generates two sub beams by deflecting the light beam in the portion contained in the light beam emitted from the light source and supposed to travel toward the outside of the aperture of the objective lens for converging the light beam on the recording surface of the recording medium so as to provide the passage of the light through the inside of the aperture of the objective lens, while generating the main beam based on the light in the other portion of the light beam emitted from the light source, and the main beam reflected from the recording surface of the recording medium contains the area involving the overlap of the zero- and the ±first-order light yielded by the track structure of the disk, while the two sub beams reflected from the recording surface of the recording medium contain no area involving the overlap of the zero-and the ±first-order light yielded by the track structure of the disk.

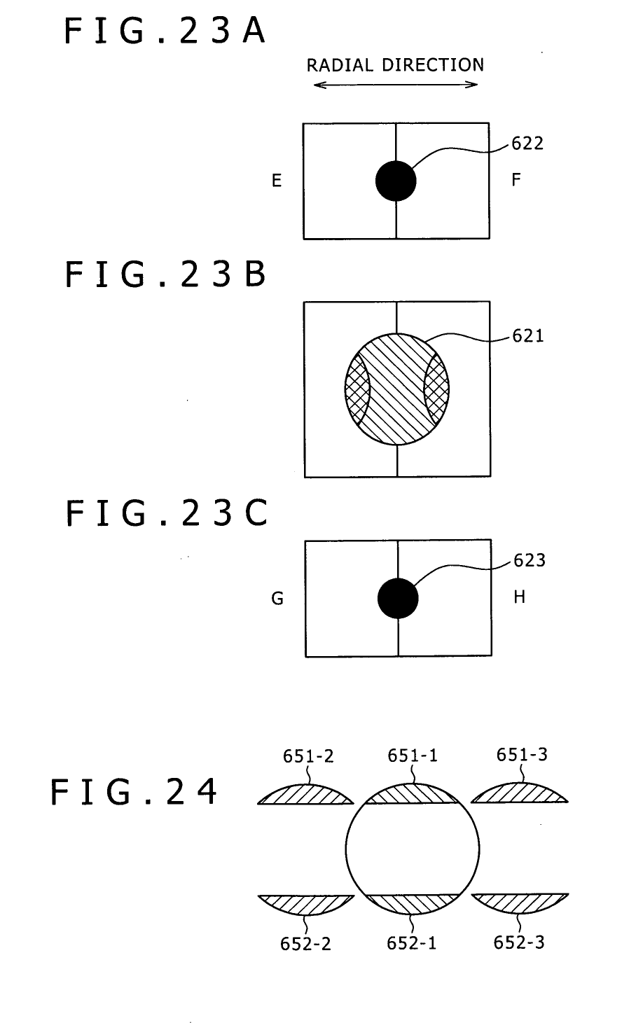

The beam splitting unit may generate the two sub beams (or the two sub beams as shown in FIGS. 23A to 23C, for instance) so that the two sub beams reflected from the recording surface of the recording medium would be respectively focused on a photo-sensing surface of the photo-detecting unit, and a control unit for providing the servo control for the disk permits a focus error signal value to be operated according to a knife edge method based on both a signal obtained from each of a plurality of rectangular areas contained in a second area and a signal obtained from each of a plurality of rectangular areas contained in a third area.

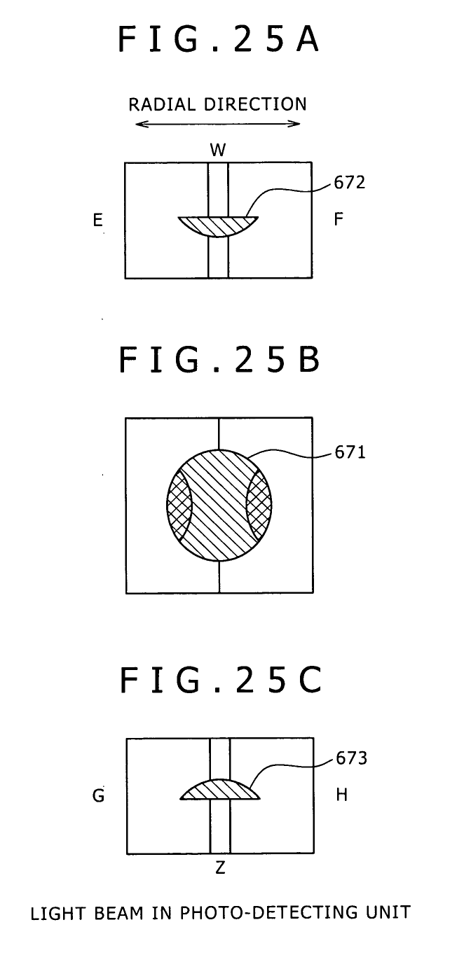

The beam splitting unit may generate the two sub beams (or the two sub beams as shown in FIGS. 25A to 25C, for instance) so that the two sub beams reflected from the recording surface of the recording medium would be respectively focused on a front focal point and a rear focal point of the photo-sensing surface of the photo-detecting unit, and the control unit for providing the servo control for the disk permits a disk tilt signal value to be operated according to a spot size detecting method based on both the signal obtained from each of the plurality of rectangular areas contained in the second area and the signal obtained from each of the plurality of rectangular areas contained in the third area.

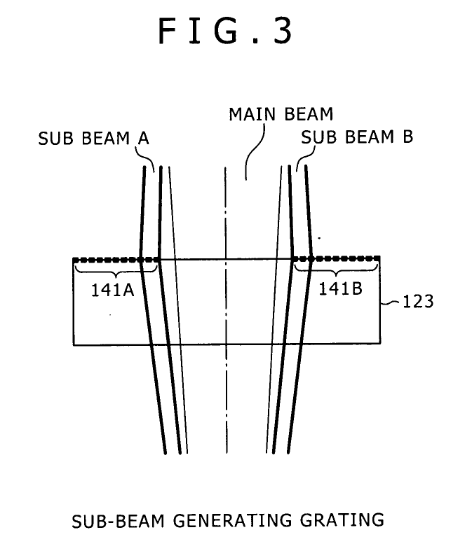

The beam splitting unit may include an optical element (or the sub-beam generating grating 123 in FIG. 3, for instance) having a grating arranged in a location that permits passage of the light beam emitted from the light source and corresponds to a periphery of the light beam.

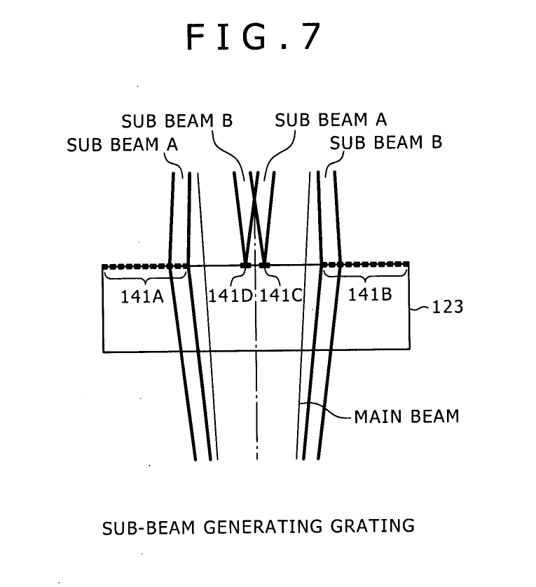

The beam splitting unit may include an optical element (or the sub-beam generating grating 123 in FIG. 7, for instance) having gratings arranged respectively in locations that permit the passage of the light beam emitted from the light source and correspond to the periphery and a center of the light beam.

The beam splitting unit may include an optical element (or a sub-beam generating prism 201 in FIG. 11, for instance) having a prism for refracting light obtainable in the location that permits the passage of the light beam emitted from the light source and corresponds to the periphery of the light beam.

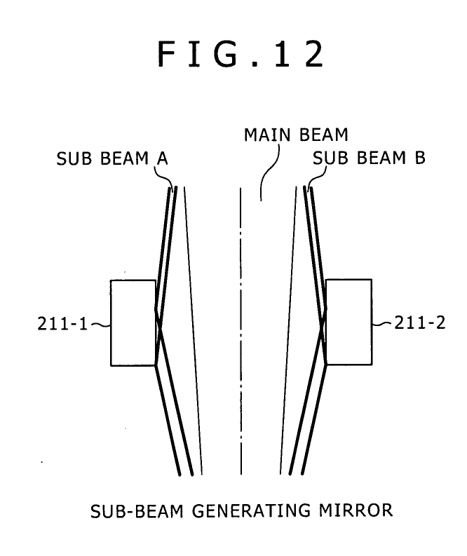

The beam splitting unit may include an optical element (or sub-beam generating mirrors 211-1 and 211-2 in FIG. 12, for instance) having mirrors for reflecting the light obtainable in the location that permits the passage of the light beam emitted from the light source and corresponds to the periphery of the light beam.

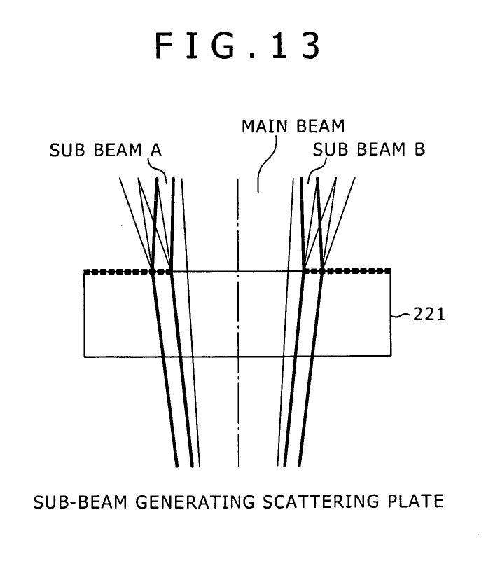

The beam splitting unit may include an optical element (or a sub-beam generating scattering plate in FIG. 13, for instance) having a scattering plate for scattering the light obtainable in the location that permits the passage of the light beam emitted from the light source and corresponds to the periphery of the light beam.

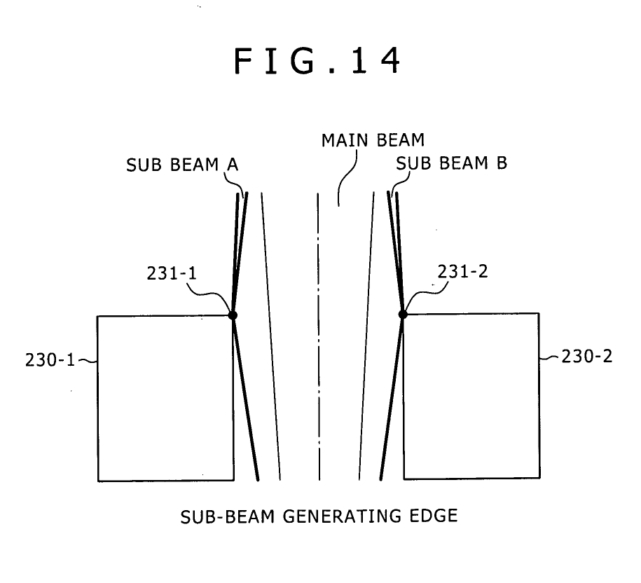

The beam splitting unit may include an optical element having light scattering materials whose non-planar portions (or sub-beam generating edges 231-1 and 231-2 in FIG. 14, for instance) are arranged in the location that permits the passage of the light beam emitted from the light source and corresponds to the periphery of the light beam.

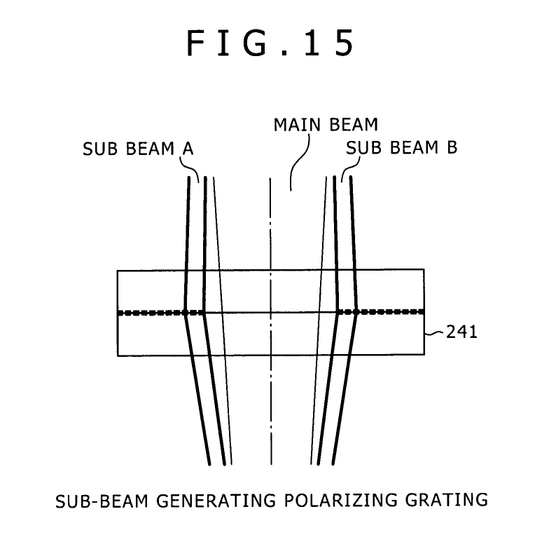

The beam splitting unit may include an optical element (or a sub-beam generating polarizing grating 241 in FIG. 15, for instance) having a polarizing grating arranged in the location that permits the passage of the light beam emitted from the light source and corresponds to the periphery of the light beam.

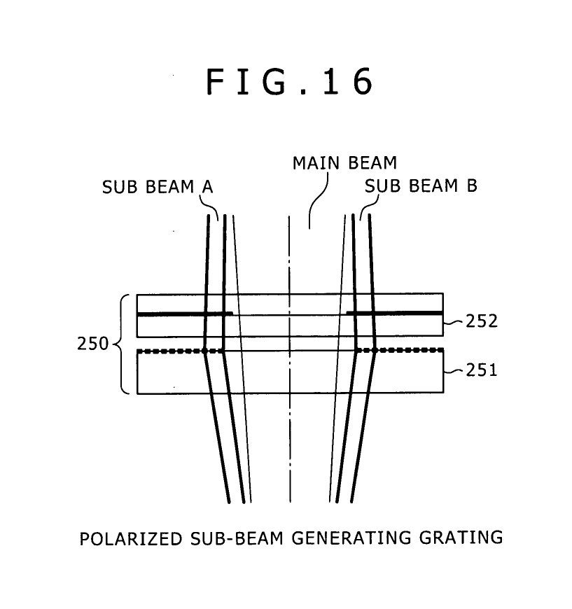

The beam splitting unit may be composed of a first optical element (or a grating 251 in FIG. 16, for instance) for diffracting the light obtainable in the location that permits the passage of the light beam emitted from the light source and corresponds to the periphery of the light beam, and a second optical element (or an area-divided phase-difference plate 252 in FIG. 16, for instance) for converting a direction of polarization of the light obtainable in the location that permits the passage of the diffracted light beam.

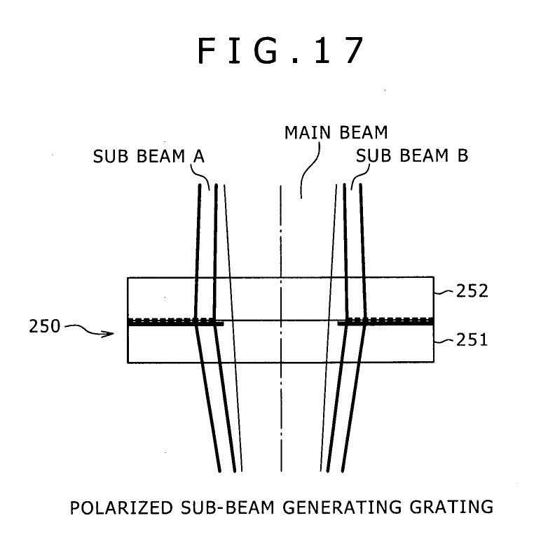

The first optical element may be formed as an integral unit of the second optical element (or a polarized sub-beam generating grating 250 in FIG. 17, for instance).

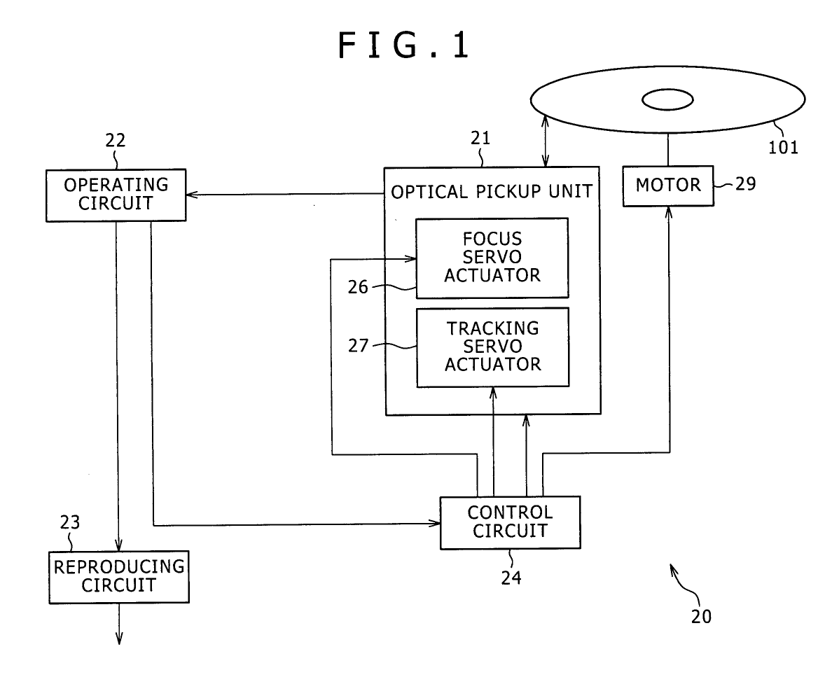

The optical disk apparatus according to the second aspect of the present invention relates to the optical disk apparatus having the optical pickup unit (or an optical pickup unit 21 in FIG. 1, for instance) having the light source (or the light source 121 in FIG. 2, for instance) for generating the light irradiated to the optical recording medium (or the optical recording medium 101 in FIG. 2, for instance) configured as the disk, the beam splitting unit (or the sub-beam generating grating 123 in FIG. 2, for instance) for splitting the light beam emitted from the light source into the main beam and the sub beams, and the photo-detecting unit (or the photo-detecting unit 127 in FIG. 2, for instance) for sensing the main and the sub beams reflected from the recording surface of the recording medium, followed by outputting the signal corresponding to the sensed light beams; and the control unit (or a control circuit 24 in FIG. 1, for instance) for providing the servo control of the optical pickup unit, wherein the beam splitting unit generates, by deflecting the light in the portion contained in the light beam emitted from the light source and supposed to travel toward the outside of the aperture of the objective lens for converging the light beam on the recording surface of the recording medium so as to provide the passage of the light through the inside of the aperture of the objective lens, the two sub beams of the type containing, in the sub beams reflected from the recording surface of the recording medium, no area involving the overlap of the zero- and the ±first-order light yielded by the track structure of the disk, while generating, based on the light in the other portion of the light beam emitted from the light source, the main beam of the type containing, in the main beam reflected from the recording surface of the recording medium, the area involving the overlap of the zero- and the ±first-order light yielded by the track structure of the disk; and the control unit generates the push-pull signal from the signal specified as the signal outputted from the photo-detecting unit and corresponding to the light spot of the sensed main beam, while generating the lens shift signal from the signal specified as the signal outputted from the photo-detecting unit and corresponding to the light spots of the sensed two sub beams, followed by generating the tracking error signal based on the push-pull signal and the lens shift signal.

FIG. 1 is a block diagram showing one configuration of an optical disk apparatus 20 involving an application of the present invention. In the shown configuration, the optical pickup unit 21 is adapted to emit light (or a laser beam) to the optical recording medium 101 configured as a DVD (digital Versatile Disc) etc., and sense the reflected light with a photo-detector having more than one photo-sensing section, followed by outputting a detection signal from each photo-sensing section of the photo-detector to an operating circuit 22.

The operating circuit 22 is adapted to calculate a signal such as a reproduced signal and a focus error signal or a tracking error signal from the detection signal fed from the optical pickup unit 21, followed by outputting the reproduced signal to a reproducing circuit 23, and also, outputting the signal such as the focus error signal or the tracking error signal to the control circuit 24.

The reproducing circuit 23 is adapted to output, to a prescribed apparatus (not shown), a signal obtained by equalizing the reproduced signal fed from the operating circuit 22, followed by binarizing and further, demodulating with error corrections.

The control circuit 24 is adapted to correct a focus error by controlling a focus servo actuator 26 in response to the focus error signal fed from the operating circuit 22 so as to shift the objective lens of the optical pickup unit 21 in an optical axis direction, for instance, and also to correct a tracking error by controlling a tracking servo actuator 27 in response to the tracking error signal fed from the operating unit 22 so as to shift the objective lens in a radial direction of the optical recording medium 101, for instance. It is to be noted that the focus servo actuator 26 and the tracking servo actuator 27 are actually provided in the form of a single actuator, allowing the objective lens described later to be mounted to the actuator.

The control circuit 24 is also adapted to turn the optical recording medium 101 at a prescribed speed by controlling a motor 29.

FIG. 2 is a block diagram showing one configuration according to one embodiment of the optical pickup apparatus involving the application of the present invention, or one detailed configuration of the optical pickup unit 21 in FIG. 1.

Referring to FIG. 2, an optical pickup apparatus 100 is operative to record information into the optical recording medium 101, and also to read out the information contained in the optical recording medium 101.

A light emitting apparatus 121 includes a semiconductor laser, for instance, and emits the light beam. The light beam (or irradiation light) emitted from the light emitting apparatus 121 is allowed to enter the sub-beam generating grating 123 by way of a polarization beam splitter (BS) 122.

The sub-beam generating grating 123 splits its own incident light beam into the main beam and the sub beams, and is followed by bringing the main and the sub beams to enter a collimator lens 124 respectively. It is to be noted that details of the sub-beam generating grating 123 and the sub beams generated by the sub-beam generating grating 123 are described later. Further, the sub beam shown by a bold line in FIG. 2 is actually generated as two beams and involves a presence of a going path (or an optical path bound for the optical recording medium 101) and a return path (or an optical path of light reflected from the optical recording medium 101), although shown in FIG. 2 is only one-side going path.

The collimator lens 124 transforms the light beams (or the main and the sub beams) in the form of diverging light into parallel beams. The parallel beams having passed through the collimator lens 124 are allowed to enter a QWP (quarter wave plate) 125.

The QWP 125 transforms the light beams incident through the collimator lens 124 into circularly polarized light, and the light beams having passed through the QWP 125 are allowed to enter the objective lens 126.

The objective lens 126 brings the light beams incident through the QWP 125 to converge on a recording surface (or a surface shown by slanted lines in FIG. 2) of the optical recording medium 101. It is to be noted that the objective lens 126 has an aperture of a prescribed size, causing the light beams at the outside of the aperture to be rejected as unnecessary light.

The light beams (or the main and the sub beams) reflected from the recording surface of the optical recording medium 101 are transformed into the parallel beams by the objective lens 26, while the light beams at the outside of the above aperture are rejected as the unnecessary light. Afterwards, the main and the sub beams repass through the QWP 125. Thus, the main and the sub beams reflected from the optical recording medium 101 are transformed into linearly polarized light different in a direction of polarization by 90 degrees from the irradiation light, followed by entering the polarization beam splitter 122 by way of the collimator lens 124 and the sub-beam generating grating 123.

The light beams incident on the polarization beam splitter 122 are reflected therefrom, followed by traveling toward the photo-detecting unit 127.

The photo-detecting unit 127 is provided on its photo-sensing surface with the photo-detector, and outputs an electric signal corresponding to the light sensed by the photo-detector.

FIG. 3 shows one detailed configuration of the sub-beam generating grating 123. As shown in FIG. 3, the sub-beam generating grating 123 is provided at its circumferential side (or its laterally opposite ends in FIG. 3) with gratings 141A and 141B. The gratings 141A and 141B generate, by diffracting peripheral light of the light beam emitted from the light emitting apparatus 121, sub beams A and B that may pass through the inside of the aperture of the objective lens 126.

Specifically, the sub-beam generating grating 123 generates the sub beams by diffracting the light in a portion contained in the light beam emitted from the light emitting apparatus 121 and supposed to be rejected as the unnecessary light by the aperture of the objective lens 126, and allows the light in an inner-side portion (or light supposed to travel without passing through the gratings 141A and 141B) of the light beam emitted from the light emitting apparatus 121 to be passed as the main beam.

The main and the sub beams having passed through the sub-beam generating grating 123 in FIG. 3 are reflected from the recording surface of the optical recording medium 10 after passage through components from the collimator lens 124 to the objective lens 126, followed by reentering the objective lens 26.

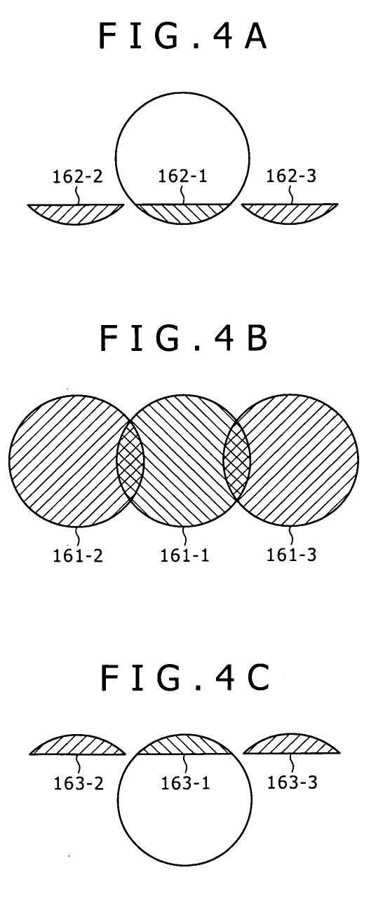

FIGS. 4A to 4C illustrate images formed in the aperture position of the objective lens 126 by the main and the sub beams incident on the objective lens 126 after being reflected from the recording surface of the optical recording medium 101. FIGS. 4A, 4B and 4C respectively show an image of the sub beam A, an image of the main beam, and an image of the sub beam B. It is to be noted that the images shown in FIGS. 4A to 4C are actually obtained in an overlap state in the aperture position of the objective lens 126, although shown in FIGS. 4A to 4C are herein respectively the images of only the sub beam A, the main beam and the sub beam B for an easy understanding.

When the light beam is reflected from the recording surface of the optical recording medium 101, ±first-order light reflected after being diffracted by a track on the recording surface enters the objective lens 126, together with zero-order light reflected from the recording surface. In FIGS. 4A to 4C, images 161-1, 162-1 and 163-1 are respectively of the zero-order light of the main beam and the sub beams A and B. Images 161-2, 162-2 and 163-2 are respectively of the —first-order light of the main beam and the sub beams A and B. Images 161-3, 162-3 and 163-3 are respectively of the +first-order light of the main beam and the sub beams A and B.

The objective lens 126 has the above aperture, so that a part of the ±first-order light of the main beam corresponding to the images 161-2 and 161-3 and the ±first-order light of the sub beams A and B corresponding to the images 162-2, 162-3, 163-2 and 163-3 are respectively rejected as the unnecessary light, causing only the zero-order light of the main beam and the sub beams A and B corresponding to the images 161-1, 162-1 and 163-1 and the part of the ±first-order light of the main beam to travel toward the photo-detecting unit 127 by way of the components from the QWP 125 to the polarization beam splitter 122.

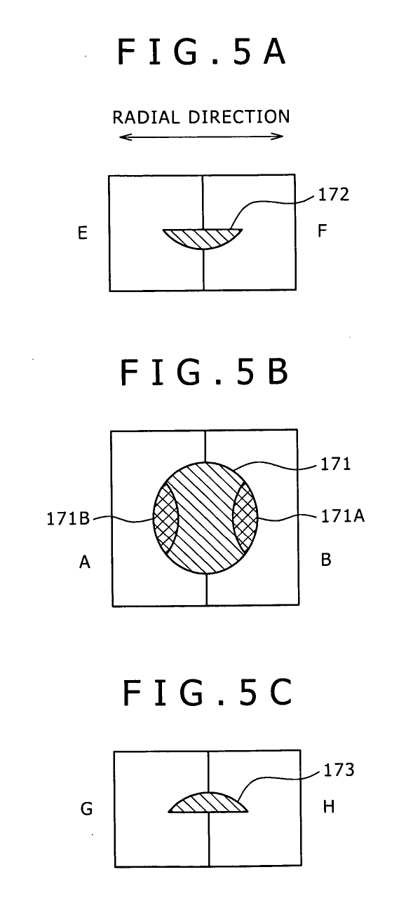

FIGS. 5A to 5C show one configuration of the photo-sensing section of the photo-detecting unit 127. In the shown configuration, the photo-sensing section of the photo-detecting unit 127 has separately a first area to sense a light spot 171 of the main beam, a second area to sense a light spot 172 of the sub beam A, and a third area to sense a light spot 173 of the sub beam B. FIG. 5B shows an area corresponding to the first area, FIG. 5A shows an area corresponding to the second area, and FIG. 5C shows an area corresponding to the third area.

Then, in the first to the third areas, the photo-sensing section of the photo-detecting unit 127 is divided into more than one rectangular small area. As shown in FIGS. 5A to 5C, the photo-sensing section in this case is provided, in the second and the third areas, with two small areas respectively to divide the light spot 172 or 173 of the sub beam A or B in the radial direction of the optical recording medium 101 taking the form of the disk. As shown in FIG. 5B, the photo-sensing section is also provided, in the first area, with two small areas to divide the light spot 171 of the main beam in the radial direction of the optical recording medium 101. It is to be noted that areas 171A and 171B in the light spot 171 of the main beam are specified as areas involving the overlap of the zero- and the ±first-order light of the main beam reflected from the recording surface of the optical recording medium 101.

When the main beam is reflected from the optical recording medium 101, a change in phase difference between the zero- and the ±first-order light with track grooves occurs in the areas 171A and 171B, leading to optical amplitude modulations. Thus, the electric signal outputted from the photo-detecting unit 127 depending on the light intensity in the areas 171A and 171B is supposed to contain an AC component produced by modulations of the light intensity in the radial direction of the photo-sensing section.

This AC component may be produced by fluctuations of a diffracted light phase yielded by the disk track structure depending on a spot position as described the above, and is referred to as an amplitude modulated signal given with a disk track pitch as one cycle, or a so-called push-pull signal.

The detection of the push-pull signal may be achieved by giving a prescribed operation to the signals respectively detected from each small area of the photo-sensing section to sense the light spot 171 of the main beam. The detection of a RF signal may be achieved by calculating a sum of the signals respectively detected from each small area of the photo-sensing section to sense the light spot of the main beam 171.

Meanwhile, as shown in FIG. 5A or 5C, the light spots 172 and 173 of the sub beams A and B contain no area involving the overlap of the zero- and the ±first-order light. Thus, the detection of a lens shift signal may be achieved by giving the prescribed operation to the signals respectively detected from each small area of the photo-sensing section to sense the light spots 172 and 173 of the sub beams A and B.

Specifically, while the disk is in turning, the objective lens follows the disk depending on eccentricity of a turning center from a disk track center, causing a shift of the aperture of the objective lens as well. The shift of the aperture causes a light beam spot position of the photo-sensing section to be shifted in the radial direction, leading to a change in light intensity balance in each small area depending on displacement of the spot position from a dividing-line position of the photo-sensing section. Thus, the lens shift signal (or a lens displacement signal) may be detected through the prescribed operation given to the signals respectively detected from each small area. It is to be noted that the lens shift signal is obtained as a signal of a DC component as against the above push-pull signal of the AC component.

In the present invention, the tracking error signal is detected based on both the push-pull signal obtained from the main beam and the lens shift signal obtained from the two sub beams.

For the detection of the tracking error using the conventional differential push-pull method, for instance, the tracking error signal is detected through the differential-operation of the push-pull signal (or the first push-pull signal in the differential push-pull method) obtained from the main beam and the push-pull signal (or the second push-pull signal in the differential push-pull method) obtained from the sub beams.

Specifically, the differential push-pull method is supposed to give an operation of canceling a DC offset (or the lens shift signal) through the differential operation of the push-pull signal obtained from the main beam and the push-pull signal obtained from the sub beams.

On the contrary, the present invention ensures that the sub beams contain no area involving the overlap of the zero- and the ±first-order light, although the main beam contains the area involving the overlap of the zero- and the ±first-order light or the area used for generation of the push-pull signal. Thus, canceling the DC offset of the push-pull signal obtained from the main beam after detecting the lens shift signal from the two sub beams allows an accurate tracking error signal to be detected.

Specifically, assuming that the divided small areas are denoted as E and F in FIG. 5A, A and B in FIG. 5B, and G and H in FIG. 5C respectively, and signal values outputted from the small areas A, B and E to H are indicated by A, B and E to H, a lens shift signal LS may be calculated by a following expression.
LS=(E−F)+(G−H)

Accordingly, a tracking error signal TRK may be calculated by a following expression through the same operation as that in the differential push-pull method.
TRK=(A−B)−k{(E−F)+(G−H)}

According to the present invention, the tracking error signal may be detected easily in this manner.

For use of the conventional differential push-pull method, the sub beam also contains the push-pull component, so that lens shift detection requires that a sub beam position be adjusted to obtain an inverse phase of the push-pull signal of each sub beam with respect to the main beam. Thus, spacing between the main beam and each sub beam is unallowable to be largely increased in order to avoid the phase shift of the push-pull component in each sub beam in the range from the inside to the outside of the disk. Consequently, when recording or reading the information into or from the optical disk specified as a multi-layered recording medium, for instance, a possibility exists that stray light from a different layer causes degradations of lens shift signal and/or tracking error signal characteristics.

Specifically, for the detection of the tracking error using the conventional differential push-pull method, increasing the spacing between the main beam and each of the two sub beams irradiated to an optical disk of a high recording density type with a small track pitch leads to an increase in phase fluctuations of the AC component in the push-pull signal obtained from the two sub beams reflected from the optical disk depending on a difference between the inside and the outside of the optical disk or between the radial direction of the optical disk and a search direction of the optical pickup. Thus, with the differential push-pull method, the operation of canceling the DC offset of the push-pull signal obtained from the sub beams brings about, due to the above phase fluctuations of the AC component, accidental canceling so far as a part of the AC component in the push-pull signal obtained from the sub beams, resulting in a possible failure to detect the tracking error signal correctly.

On the contrary, according to the present invention, the sub beams taking a shape as shown in FIGS. 4A to 4C and containing no area involving the overlap of the zero- and the ±first-order light are generated by the sub-beam generating grating as shown in FIG. 3, permitting the spacing between the main beam and each of the two sub beams to be increased sufficiently.

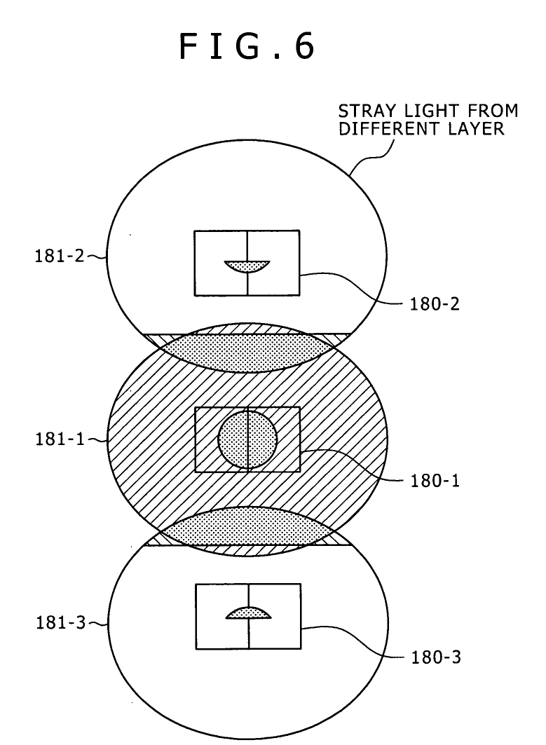

Accordingly, the impact of the stray light from the different layer is avoidable even when recording or reading the information into or from the optical disk specified as the multi-layered recording medium, provided that the first to the third areas of the photo-sensing section of the photo-detecting unit 127 are arranged as shown in FIG. 6, for instance.

FIG. 6 shows one arrangement of the first area (or an area 180-1) to sense the light spot of the main beam, the second area (or an area 180-2) to sense the light spot of the sub beam A and the third area (or an area 180-3) to sense the light spot of the sub beam B. A central spot 181-1 shown in FIG. 6 is a light spot by the stray light from the different layer with respect to the main beam, and upper and lower spots 181-2 and 181-3 in FIG. 6 are light spots by the stray light from the different layer with respect to the sub beams A and B, respectively.

As shown in FIG. 6, the areas 180-2 and 180-3 are sufficiently spaced from the area 180-1, so that the spot 181-1 is conditioned to be unaffected by light sensing by the areas 180-2 and 180-3. Further, the spots 181-2 and 181-3 are also conditioned to be unaffected by the light sensing by the areas 180-2 and 180-3, since the sub beams takes the same shape (or the shape of a portion shown by slant lines in FIG. 6) as the sub beams previously described with reference to FIGS. 4A to 4C. Thus, in relation to the signal such as the signal outputted correspondingly to the light spot sensed by the photo-detecting unit 127, the impact of the stray light from the different layer is avoidable.

Further, not the ±first-order diffracted light of the main beam but the light in an area different from that of the main beam is generated as the sub beam, so that the sub beam A or B permits contribution toward an improvement in utilization of the light emitted from the light source, resulting in a reduction in apparatus-related cost.

As described the above, according to the present invention, the accurate tracking error signal may be detected with the simple configuration.

While the above embodiment has been described as related to the case where the peripheral light contained in the light beam is utilized to generate the sub beams A and B, or the case where the sub beams A and B as shown in FIGS. 4A and 4C are generated through the sub-beam generating grating 123 as shown in FIG. 3, it will be appreciated that the peripheral and inside light contained in the light beam may be also utilized to generate the sub beams A and B respectively.

FIG. 7 shows one different configuration of the sub-beam generating grating 123 in detail. Unlike the case in FIG. 3, the sub-beam generating grating 123 in this case is provided on its circumferential side (or laterally opposite ends in FIG. 7) with gratings 141A and 141B, and, on its inner side (or the center in FIG. 7) with gratings 141C and 141D. In this case, the gratings 141A and 141C permit generation of the sub beam A that may pass through the inside of the aperture of the objective lens 126, while the gratings 141B and 141D permit the generation of the sub beam B that may pass through the inside of the aperture of the objective lens.

The light beam (or the main and the sub beams) having passed through the sub-beam generating grating 123 as shown in FIG. 7 is reflected from the recording surface of the optical recording medium 101 after the passage through the components from the collimator lens 124 to the objective lens 126, followed by reentering the objective lens 126.

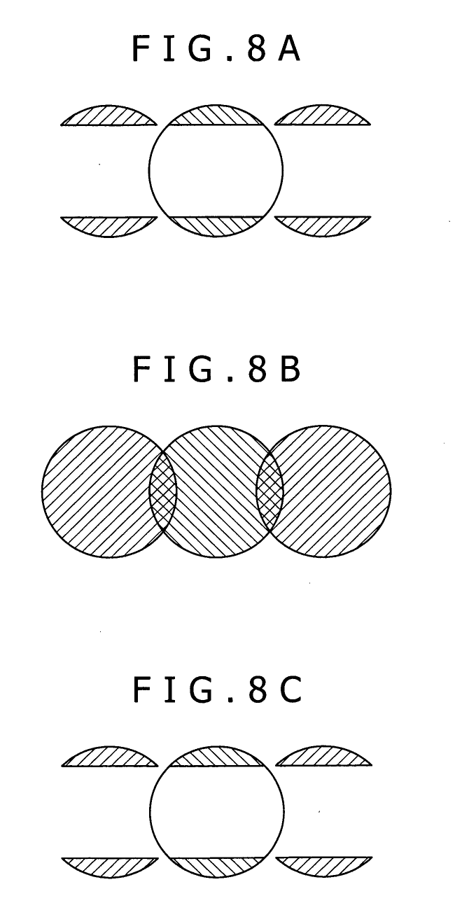

FIGS. 8A to 8C shows images formed in the aperture position of the objective lens 126 by the main and the sub beams incident on the objective lens 126 after being reflected from the recording surface of the optical recording medium 101. FIGS. 8A, 8B and 8C respectively show an image of the sub beam A, an image of the main beam, and an image of the sub beam B. It is to be noted that the images shown in FIGS. 8A to 8C are actually obtained in the overlap state in the aperture position of the objective lens 126, although shown in FIGS. 8A to 8C are herein respectively the images of only the sub beam A, the main beam and the sub beam B for the easy understanding.

In this case, like the case previously described with reference to FIGS. 4A to 4C, when the light beam is reflected from the recording surface of the optical recording medium 101, the ±first-order light reflected after being diffracted by the track on the recording surface enters the objective lens 126, together with the zero-order light reflected from the recording surface, while the part of the ±first-order light of the main beam and the ±first-order light of the sub beams A and B are rejected respectively as the unnecessary light by the aperture of the objective lens 126, causing only the zero-order light of the main and the sub beams A and B and the part of the ±first-order light of the main beam to travel toward the photo-detecting unit 127 by way of the components from the GWP 125 to the polarization beam splitter 122.

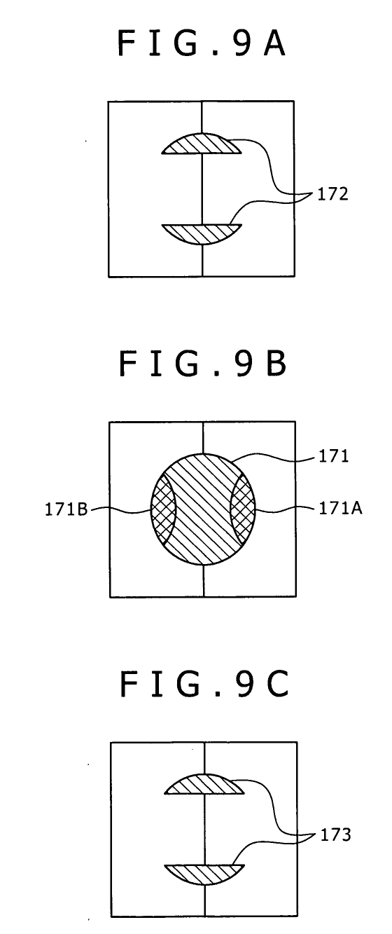

FIGS. 9A to 9C show light spots by the main and the sub beams generated by the sub-beam generating grating 123 as shown in FIG. 7, or the light spot 171 of the main beam and the light spots 172 and 173 of the sub beams A and B sensed with the photo-sensing section of the photo-detecting unit 127. FIGS. 9A to 9C are views respectively corresponding to FIGS. 5A to 5C described the above, that is, FIG. 9B shows an area corresponding to the first area, FIG. 9A shows an area corresponding to the second area, and FIG. 9C shows an area corresponding to the third area.

The light spots of the sub beams A and B in FIGS. 9A and 9C are respectively of the same shape. Specifically, the light spots of the sub beams A and B shown in FIGS. 9A and 9C take the same shape, as against that the light spots of the sub beams A and B shown in FIGS. 5A and 5C are respectively of 180° different shapes.

Use of the two sub beams taking the same shape as described the above allows the impacts by various perturbations and/or defects to be given symmetrically, enabling control of degradations of the lens shift signal and/or RF signal characteristics.

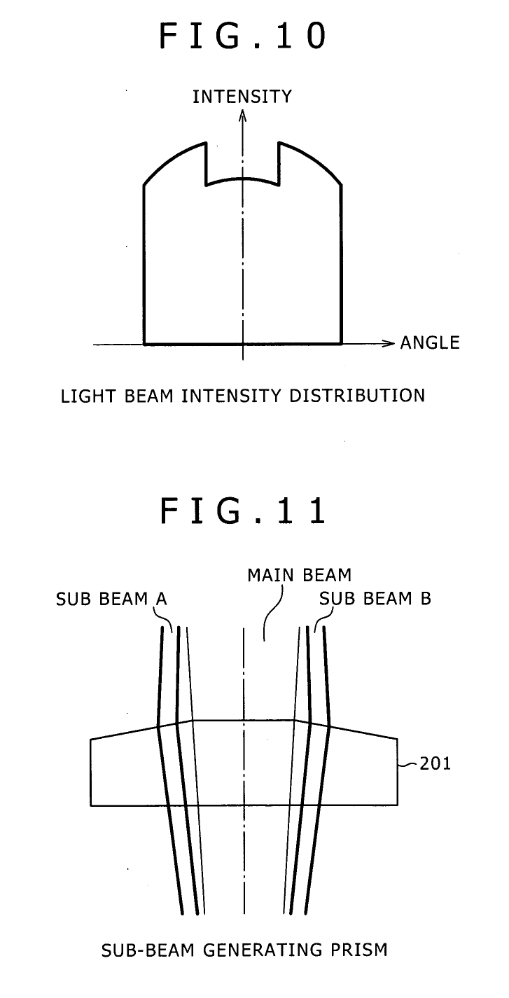

For the generation of the sub beams by the sub-beam generating grating 123 as shown in FIG. 7, a distribution of light intensity of the main beam is obtained as shown in FIG. 10. FIG. 10 is a graphic representation of the distribution of the light intensity of the main beam, where a light beam emission (incidence) intensity is scaled at a vertical axis, with a light beam emission (incidence) angle scaled at a horizontal axis. As shown in FIG. 10, the distribution of the light intensity of the main beam provides, relatively to a decrease in intensity of the light in the vicinity of the center, an increase in intensity of the light around the aperture of the objective lens up to a sufficient level to increase a RIM intensity, resulting in an improvement in signal characteristics of the detected lens shift signal and/or the detected RF signal.

While the above embodiment has been described as related to the case where the sub-beam generating grating 123 is applied to generate the sub beams (and the main beam), it will be appreciated that a different optical element may be substituted for the sub-beam generating grating 123 in FIG. 2 to generate the same sub beams (and the same main beam) as those in the above case.

FIG. 11 shows one configuration of a sub-beam generating prism 201 applicable as a substitute for the sub-beam generating grating 123. As shown in FIG. 11, the sub-beam generating prism 201 generates, by refracting the peripheral light of the light beam emitted from the light emitting device 121, the sub beams A and B that may pass through the inside of the aperture of the objective lens 126.

Specifically, the sub-beam generating prism 201 generates the sub beams by diffracting the light in a portion contained in the light beam emitted from the light emitting device 121 and supposed to be rejected as the unnecessary light by the aperture of the objective lens 126, while allowing the light in an inner-side portion of the light beam emitted from the light emitting device 121 to be passed as the main beam, thereby enabling the same main beam and the same sub beams A and B as those in the case previously described with reference to FIGS. 4 and 5 to be generated.

FIG. 12 shows one configuration of sub-beam generating mirrors 211-1 and 211-2 applicable as the substitute of the sub-beam generating grating 123. As shown in FIG. 12, the sub-beam generating mirrors 211-1 and 211-2 generate, by reflecting the peripheral light of the light beam emitted from the light emitting device 121, the sub beams A and B that may pass through the inside of the aperture of the objective lens 126.

Specifically, the sub-beam generating mirrors 211-1 and 211-2 generate the sub beams by reflecting the light in the portion contained in the light beam emitted from the light emitting device 121 and supposed to be rejected as the unnecessary light by the aperture of the objective lens 126, while allowing the light in the inner-side portion of the light beam emitted from the light emitting device 121 to be passed as the main beam, thereby enabling the same main beam and the same sub beams A and B as those in the case previously described with reference to FIGS. 4 and 5 to be generated.

FIG. 13 shows one configuration of a sub-beam generating scattering plate 221 applicable as the substitute of the sub-beam generating grating 123. As shown in FIG. 13, the sub-beam generating scattering plate 221 generates, from scattered light generated in such a manner that the light beam emitted from the light emitting device 121 passes through the scattering plate, the sub beams A and B that may pass through the inside of the aperture of the objective lens 126.

Specifically, the sub-beam generating scattering plate 221 generates the sub beams from the scattered light in the portion contained in the light beam emitted from the light emitting device 121 and supposed to be rejected as the unnecessary light by the aperture of the objective lens 126, while allowing the light in the inner-side portion of the light beam emitted from the light emitting device 121 to be passed as the main beam, thereby enabling the same main beam and the same sub beams A and B as those in the case previously described with reference to FIGS. 4 and 5 to be generated.

FIG. 14 shows one configuration of sub-beam generating edges 231-1 and 231-2 applicable as the substitute of the sub-beam generating grating 123. As shown in FIG. 14, the sub beam generating edges 231-1 and 231-2 are formed of, for instance, edges (or non-planar portions) of light scattering materials 230-1 and 230-2 such as the scattering plates. Then, the sub beams A and B that may pass through the inside of the aperture of the objective lens 126 are generated from the scattered light generated in such a manner that the light beam emitted from the light emitting device 121 strikes the sub-beam generating edges 231-1 and 231-2.

Specifically, the sub-beam generating edges 231-1 and 231-2 generate the sub beams from the scattered light in the portion contained in the light beam emitted from the light emitting device 121 or supposed to be rejected as the unnecessary light by the aperture of the objective lens 126, while allowing the light in the inner-side portion of the light beam emitted from the light emitting device 121 to be passed as the main beam, thereby enabling the same main beam and the same sub beams A and B as those in the case previously described with reference to FIGS. 4 and 5 to be generated.

FIG. 15 shows one configuration of a sub-beam generating polarizing grating 241 applicable as the substitute of the sub-beam generating grating 123. The sub-beam generating polarizing grating 241 takes the same configuration as the sub-beam generating grating 123 in FIG. 3, and also generates the same main beam and the same sub beams A and B as those in the case previously described with reference to FIGS. 4 and 5.

With the sub-beam generating polarizing grating 241, the going path and the return path of the light beam give the polarization of the light in different directions. Thus, the sub-beam generating polarizing grating 241, even if placed in the location where the light beam is supposed to pass both ways, is allowed to act (or diffract the peripheral light) on the light only in the going path, permitting less generation of the stray light during focus searching and/or in the course of recording or reproducing the information into or from the multi-layered optical recording medium, for instance.

FIG. 16 shows one configuration of a polarized sub-beam generating grating 250 applicable as the substitute of the sub-beam generating grating 123. The polarized sub-beam generating grating 250 is composed of, for instance, a grating 251 of the same configuration as the sub-beam generating grating 123 in FIG. 3, and an area-divided phase-difference plate 252 for converting the direction of polarization of the light in a location adapted for the passage of the sub beams, and also generate the same main beam and the same sub beams A and B as those in the case previously described with reference to FIGS. 4 and 5.

The polarized sub-beam generating grating 250 gives to only the sub beams A and B a difference in light phase between the going path and the return path. Thus, even though an overlap of the main beam with the sub beams A and B occurs in the course of recording or reproducing the information into or from the multi-layered optical recording medium, for instance, it is allowable to avoid interference fringes caused by the above overlap.

It is to be noted that the polarized sub-beam generating grating 250 may be also in the form of an integral unit of the grating 251 with the area-divided phase-difference plate 252 as shown in FIG. 17.

One different configuration of the optical pickup apparatus 100 in FIG. 2 is now described.

FIG. 18 shows one configuration of an optical pickup apparatus 300 specified as one different configuration of the optical pickup apparatus 100 in FIG. 2. Referring to FIG. 18, a light emitting device 321 and components from a sub-beam generating grating 323 to a lens 326 are the same as the light emitting device 121 and the components from the sub-beam generating grating 123 to the objective lens 126 in FIG. 2, so that their detailed description are left out.

The optical pickup apparatus 300 in FIG. 18 is provided with no polarization beam splitter, but has a photo-detecting unit 327 provided with a bent-up mirror 327A for polarizing and splitting the light, unlike the case in FIG. 2. With this configuration, the light beam in the going path may travel toward the sub-beam generating grating 323 after being reflected by the bent-up mirror 327A, while the light beam in the return path may travel toward a photo-sensing section 327B or 327C of the photo-detecting unit 327 by way of the bent-up mirror 327A.

Like the case of the optical pickup apparatus 100, the optical pickup apparatus 300 also enables the tracking error signal to be detected easily by applying the configuration previously described with reference to FIGS. 5A to 5C to the photo-sensing section 327B or 327C of the photo-detecting unit 327.

The light emitting device 321 and the photo-detecting unit 327 shown in FIG. 18 are in the form of an integrated unit as a component mounted to the optical pickup apparatus etc., so that the application of the configuration shown in FIG. 18 to the optical pickup apparatus may provide the optical pickup apparatus at lower cost.

It is to be noted that the optical elements previously described with reference to FIGS. 11 to 17 are also applicable as the substitute of the sub-beam generating grating 323.

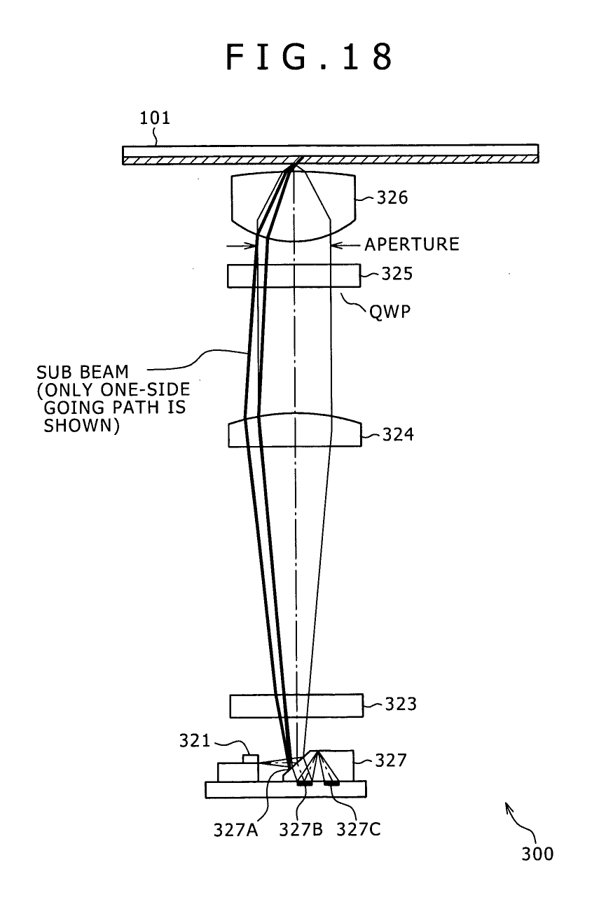

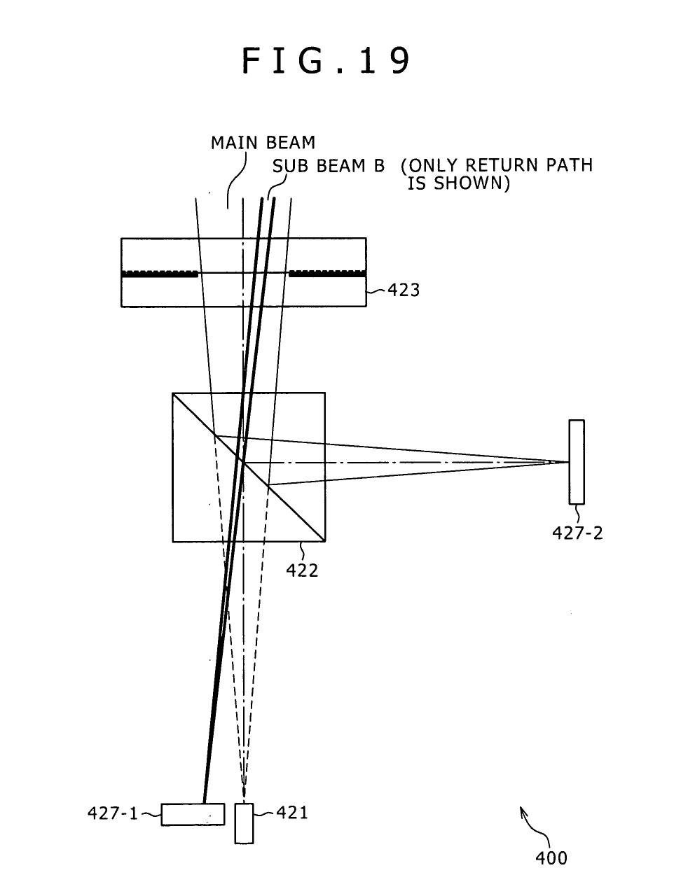

FIG. 19 shows one configuration of an optical pickup apparatus 400 specified as one further different configuration of the optical pickup apparatus 100 in FIG. 2. Referring to FIG. 19, a light emitting device 421 and a polarization beam splitter 422 are the same as the light emitting device 121 and the polarization beam splitter 122 in FIG. 2, so that their detailed description is left out. Further, in FIG. 19, although there are not shown the components from the collimator lens 124 to the objective lens 126, these components are supposed to be placed like the case in FIG. 2. It is to be noted that shown by the bold line in FIG. 19 is only the sub beam B in the return path, out of the two sub beams.

The optical pickup apparatus 400 in FIG. 19 is provided with a polarized sub-beam generating grating 423 of the same configuration as the polarized sub-beam generating grating 250 previously described with reference to FIG. 17, and has a photo-detecting unit including, as separate units, a photo-detecting unit 427-2 to sense the light spot of the main beam and a photo-detecting unit 427-1 to sense the light spot of each sub beam, unlike the case in FIG. 2.

The area-divided phase-difference plate of the polarized sub-beam generating grating 423 is in the form of a ½ wave plate, in which the direction of polarization of the sub beams is approximately orthogonal to the direction of polarization of the main beam.

Specifically, the polarized sub-beam generating grating 423 gives only to the sub beams the difference in direction of light polarization between the going path and the return path. Thus, the main beam in the return path may travel toward the photo-detecting unit 427-2 after being reflected by the polarization beam splitter 422, while the sub beams in the return path may travel toward the photo-detecting unit 427-1 after being transmitted through the polarization beam splitter 422.

The application of the above configuration to the optical pickup apparatus enables mutual impacts of the main and the sub beams to be eliminated even if the spacing between the main beam and each sub beam is unallowable to be largely increased. Thus, even though the overlap of the main beam with the sub beams A and B occurs in the case of recording or reproducing the information into or from the multi-layered optical recording medium, it is allowable to avoid the interference fringes caused by the above overlap, enabling the accurate detection of the servo signal and/or the RF signal.

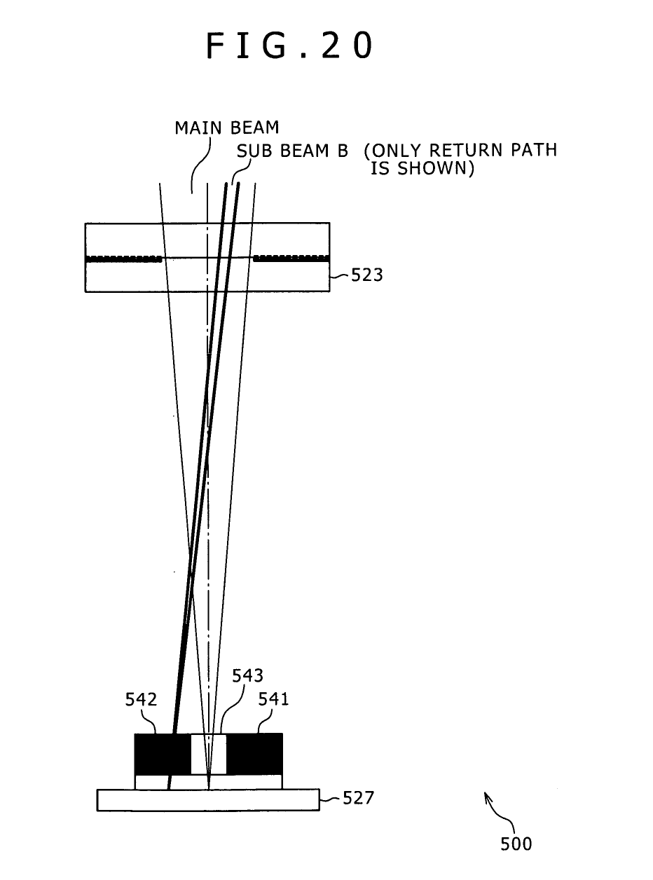

FIG. 20 shows one configuration of an optical pickup apparatus 500 specified as one different configuration of the optical pickup apparatus 400 in FIG. 19. The optical pickup apparatus 500 shown in FIG. 20, while being provided with the polarized sub-beam generating grating 523 of the same configuration as the polarized sub-beam generating grating 250 like the case in FIG. 19, is provided with no polarization beam splitter, and has a photo-detecting unit 527 including no two separate units, unlike the case in FIG. 19.

In the optical pickup apparatus 500, the photo-detecting unit 527 has, on its surface, a polarization area which is divided into an area 541 permitting the passage of the sub beam A, an area 543 permitting the passage of the main beam, and an area 542 permitting the passage of the sub beam B. The areas 541 and 542 serve as the polarization beam splitter for providing transmission of s-polarized light and reflection of p-polarized light, for instance. The area 543 serves as the polarization beam splitter for providing the reflection of the s-polarized light and the transmission of the p-polarized light, for instance.

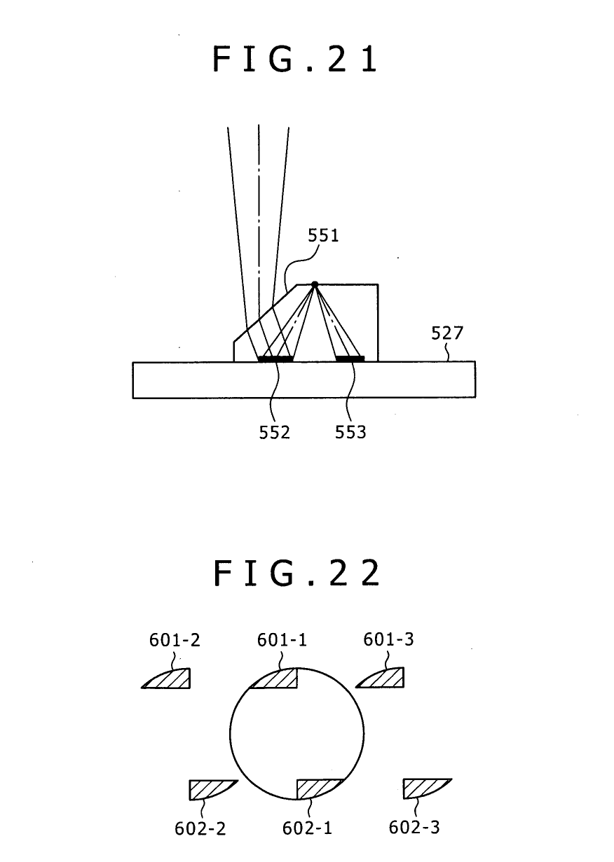

FIG. 21 is a view showing the photo-detecting unit as seen from its side face. As shown in FIG. 21, a face 551 of the photo-detecting unit 527 is in the form of a bent-up mirror for polarizing and splitting the light. Thus, the light beam in the going path may travel toward the polarized sub-beam generating grating 523 after being reflected from the face 551, while the light beam in the return path may travel toward a photo-detecting section 552 or 553 after being transmitted through the face 551.

The area-divided phase-difference plate of the polarized sub-beam generating grating 523 is in the form of the ½ wave plate, and the polarized sub-beam generating grating 523 gives to the main and the sub beams the difference in light phase, so that the sub beams in the return path are obtained as the s-polarized light beams, while the main beam in the return path is obtained as the p-polarized light beam. Thus, the sub beam A or B (or the s-polarized light) in the return path, although being transmitted through the area 541 or 542, undergoes the reflection in the area 543. On the other hand, the main beam (or the p-polarized light) in the return path, although being transmitted through the area 543, undergoes the reflection in the area 541 or 542.

As described the above, the optical pickup apparatus 500 may control interference between the main and the sub beams in the photo-sensing section 552 or 553 of the photo-detecting unit 527, and also permits the contributions to provide a smaller-sized optical pickup apparatus, as compared with the case where the photo-detecting unit includes the two separate units like the case in FIG. 19, for instance.

By the way, while the above optical pickup apparatus 100, 300, 400 or 500 has been described mainly as the apparatus that enables the accurate tracking error signal detection with the simple configuration, it will be appreciated that the focus error signal may be also detected using the sub beams by the optical pickup apparatus 100, 300, 400 or 500.

For the detection of the focus error signal by the optical pickup apparatus 100, 300, 400 or 500, a change of the shape of the sub beams generated by the sub-beam generating grating 123 (or any optical element substituted for the sub-beam generating grating 123) is effected. The change of the sub beam shape will do by modifying the sub-beam generating grating 123 in such a manner that the grating is provided for only one-side area in the radial direction of the disk to generate the sub beams of the shape as shown in FIG. 22, for instance.

FIG. 22 shows images of the sub beams obtained when detecting the focus error signal by the optical pickup apparatus 100, for instance, or images formed in the aperture position of the objective lens 126 by the sub beams A and B incident on the objective lens 126 after being reflected from the recording surface of the optical recording medium 101.

When the light beam is reflected from the recording surface of the optical recording medium 101, the ±first-order light reflected after being diffracted by the track on the recording surface is generated together with the zero-order light reflected on the recording surface. An image 601-1 is of the zero-order light of the sub beam A, and an image 602-1 is of the zero-order light of the sub beam B. An image 601-2 or 601-3 is of the ±first-order light of the sub beam A, and an image 602-2 or 602-3 is of the ±first-order light of the sub beam B.

The change of the shape of the sub beams A and B to the shape as shown in FIG. 22 enables the focus error detection using the knife edge method. With the knife edge method, the focus error may be detected by obtaining a shape difference signal of the sensed light spot after generating the light beams that may be focused on the photo-detecting unit and take such a shape that the light spot of the light beam reflected from the recording surface of the recording medium may be sensed in one of small halved areas in the photo-sensing section of the photo-detecting unit 127.

The ±first-order light of the sub beams A and B is rejected as the unnecessary light by the aperture of the objective lens 126, causing the zero-order light of the sub beams A and B corresponding to the images 601-1 and 602-1 to travel toward the photo-detecting unit 127 by way of the components from the QWP 125 to the polarization beam splitter 122.

FIGS. 23A to 23C are views showing one configuration of the photo-sensing section of the photo-detecting unit 127. In the shown configuration, the photo-sensing section of the photo-detecting unit 127, while taking the same configuration as that in the case of FIGS. 5A to 5C, gives a difference in focal point to the main beam and the sub beams A and B, unlike the case in FIGS. 5A to 5C. Specifically, the main beam is sensed as not the light focused on the photo-sensing section of the photo-detecting unit 127 but the light spot of a prescribed size. On the other hand, the sub beams A and B are focused on the photo-sensing section of the photo-detecting unit 127, in which case, the sensed light spot is conditioned to take the shape approximately close to a dot. For instance, the difference in focal point may be given to the main beam and the sub beams A and B by applying different powers to the gratings of the sub-beam generating grating 123 respectively, or by varying the power and/or an optical path length of only the main beam in the course of the return path.

Assuming that values of the signals outputted from the small areas E to H are respectively indicated by E to H, a focus error signal FE may be calculated by a following expression using the knife edge method.
FE=(E−F)−(G−H)

It will be appreciated that the lens shift signal LS may be also calculated by a following expression.
LS=(E+F)(G+H)

As described the above, the present invention may provide the detection of the accurate tracking error signal by the simple configuration, and also, enables the detection of the focus error signal.

The optical pickup apparatus 100, 300, 400 or 500 also permits not only the focus error signal but also a disk tilt signal to be detected.

For the detection of the disk tilt signal by the optical pickup apparatus 100, 300, 400 or 500, the sub beams generated by the sub-beam generating grating 123 (or any optical element substituted for the sub-beam generating grating 123) is given defocusing by a preset distance. The change of the sub-beam focal point will do by applying the different powers to the gratings of the sub-beam generating grating 123 respectively, or by varying the power and/or the optical path length in the course of the return path.

FIG. 24 shows images of the sub beams obtained when detecting the disk tilt signal by the optical pickup apparatus 100, for instance, or images formed in the aperture position of the objective leans 126 by the sub beams A and B incident on the objective lens 126 after being reflected from the recording surface of the optical recording medium 101.

When the light beam is reflected from the recording surface of the optical recording medium 101, the ±first-order light reflected after being diffracted by the track on the recording surface is generated together with the zero-order light reflected on the recording surface. An image 651-1 is of the zero-order light of the sub beam A, and an image 652-1 is of the zero-order light of the sub beam B. An image 651-2 or 651-3 is of the ±first-order light of the sub beam A, and an image 652-2 or 652-3 is of the ±first-order light of the sub beam B. It is to be noted that while the sub beams A and B in FIG. 24 take the approximately same shape as that in the case previously described with reference to FIGS. 4A to 4C, there is the difference in focal point between the main beam and the sub beams A and B in this case, unlike the case in FIGS. 4A to 4C.

The ±first-order light of the sub beams A and B is rejected as the unnecessary light by the aperture of the objective lens 126, causing the zero-order light of the sub beams A and B corresponding to the images 651-1 and 652-1 to travel toward the photo-detecting unit 127 by way of the components from the QWP 125 to the polarization beam splitter 122.

FIGS. 25A to 25C show one configuration of the photo-sensing section of the photo-detecting unit 127 for the detection of the disk tilt signal. In the shown configuration, the second area to sense the light spot 172 of the sub beam A is formed as shown in FIG. 25A, while the third area to sense the light spot 173 of the sub beam B is formed as shown in FIG. 25C, unlike the case in FIG. 5A or 5C.

Specifically, as shown in FIGS. 25A and 25C, in the second and the third areas, the photo-sensing section of the photo-detecting unit 127 has three small areas to divide a light spot 672 or 673 of the sub beam A or B in the radial direction of the optical recording medium 101.

As described the above, for the detection of the tilt signal, the sub-beam focal point is changed, so that the sub beam A is given the focal point such that the sub beam A may be focused on a front focal point obtained based on the location of the photo-sensing section of the photo-detecting unit 127, while the sub beam B is given the focal point such that the sub beam B may be focused on a rear focal point obtained based on the location of the photo-sensing section of the photo-detecting unit 127.

Focusing the two sub beams respectively to bring each sub beam to the front or the rear focal point obtained based on the location of the photo-sensing section of the photo-detecting unit 127 enables the focus error detection using the spot size detecting method. In this case, assuming that values of the signals outputted from the small areas E to H, W and Z are indicated by E to H, W and Z, the focus error signal FE may be calculated by a following expression.
FE=(W+G+H)(Z+E+F)

Accordingly, a disk tilt signal DT may be calculated by a following expression.
DT=(W+Z)(E+F+G+H)

As described the above, the present invention may provide the detection of the accurate tracking error signal by the simple configuration, and also enables the detection of the disk tilt signal.

The present invention also ensures that adjustment such as defocusing may be given only to the sub beams at will without affecting the main beam as described the above, also enabling the detection of a spherical aberration signal by giving a predetermined spherical aberration to the sub beams, for instance.

The present invention contains subject mater related to Japanese Patent Application No. JP2005-372729 filed in the Japanese Patent Office on Dec. 26, 2005, the entire contents of which being incorporated herein by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An optical pickup apparatus comprising:
a light source for generating light irradiated to an optical recording medium configured as a disk;
a beam splitting unit for splitting an optical beam emitted from said light source into a main beam and sub beams; and
a photo-detecting unit for sensing said main and said sub beams reflected from a recording surface of said recording medium, and outputting a signal corresponding to the sensed light beams;
wherein said beam splitting unit generates two sub beams by deflecting a portion of the light contained in the light beam emitted from said light source traveling toward an outside of an aperture of an objective lens for converging the light beam on the recording surface of said recording medium so as to provide passage of the light through an inside of the aperture of said objective lens, while generating the main beam based on the other portion of the light beam emitted from said light source; and
said main beam reflected from the recording surface of said recording medium contains an area involving overlap of zero- and ±first-order light yielded by a track structure of said disk, while said two sub beams contain no area involving the overlap of the zero- and the ±first-order light yielded by the track structure of said disk.

2. The optical pickup apparatus according to claim 1, wherein said beam splitting unit generates the two sub beams respectively taking the same spot shape.

3. The optical pickup apparatus according to claim 1, wherein said photo-detecting unit has a first area to sense said main beam, and a second area and a third area to respectively sense said two sub beams, and each of said first to said third areas includes a plurality of rectangular areas arranged in a radial direction of said disk.

4. The optical pickup apparatus according to claim 3, wherein a control unit for providing servo control for said disk permits a lens shift signal value to be operated based on both a signal obtained from each of said plurality of rectangular areas contained in said second area and a signal obtained from each of said plurality of rectangular areas contained in said third area, and also, a push-pull signal value to be operated based on a signal obtained from each of said plurality of rectangular areas contained in said first area, causing a tracking error signal to be generated based on said lens shift signal and said push-pull signal.

5. The optical pickup apparatus according to claim 4, wherein the control unit for providing the servo control for said disk further permits a focus error signal value to be operated based on both the signal obtained from each of said plurality of rectangular areas contained in said second area and the signal obtained from each of said plurality of rectangular areas contained in said third area.

6. The optical pickup apparatus according to claim 5, wherein said beam splitting unit generates said two sub beams such that said two sub beams reflected from the recording surface of said recording medium are respectively focused on a photo-sensing surface of said photo-detecting unit, and the control unit for providing the servo control for said disk permits the focus error signal value to be operated using a knife edge method based on both the signal obtained from each of said plurality of rectangular areas contained in said second area and the signal obtained from each of said plurality of rectangular areas contained in said third area.

7. The optical pickup apparatus according to claim 4, wherein the control unit for providing the servo control for said disk further permits a disk tilt signal value to be operated based on both the signal obtained from each of said plurality of rectangular areas contained in said second area and the signal obtained from each of said plurality of rectangular areas contained in said third area.

8. The optical pickup apparatus according to claim 7, wherein said beam splitting unit generates said two sub beams such that said two sub beams reflected from the recording surface of said recording medium are respectively focused on a front focal point and a rear focal point of the photo-sensing surface of said photo-detecting unit, and the control unit for providing the servo control for said disk permits the disk tilt signal value to be operated using a spot size detecting method based on the signal obtained from each of said plurality of rectangular areas contained in said second area and the signal obtained from each of said plurality of rectangular areas contained in said third area.

9. The optical pickup apparatus according to claim 1, wherein said beam splitting unit includes an optical element having a grating arranged in a location that permits passage of the light beam emitted from said light source and corresponds to a periphery of said light beam.

10. The optical pickup apparatus according to claim 1, wherein said beam splitting unit includes an optical element having gratings arranged respectively in locations that permit passage of the light beam emitted from said light source and correspond to a periphery and a center of said light beam.

11. The optical pickup apparatus according to claim 1, wherein said beam splitting unit includes an optical element having a prism for refracting light obtainable in a location that permits passage of the light beam emitted from said light source and corresponds to a periphery of said light beam.

12. The optical pickup apparatus according to claim 1, wherein said beam splitting unit includes an optical element having mirrors for reflecting light obtainable in a location that permits the light beam emitted from said light source and corresponds to a periphery of said light beam.

13. The optical pickup apparatus according to claim 1, wherein said beam splitting unit includes an optical element having a scattering plate for scattering light obtainable in a location that permits passage of the light beam emitted from said light source and corresponds to a periphery of said light beam.

14. The optical pickup apparatus according to claim 1, wherein said beam splitting unit includes an optical element having light scattering materials whose non-planar portions are arranged in a location that permits passage of the light beam emitted from said light source and corresponds to a periphery of said light beam.

15. The optical pickup apparatus according to claim 1, wherein said beam splitting unit includes an optical element having a polarizing grating arranged in a location that permits passage of the light beam emitted from said light source and corresponds to a periphery of said light beam.

16. The optical pickup apparatus according to claim 1, wherein said beam splitting unit is composed of a first optical element for diffracting light obtainable in a location that permits passage of the light beam emitted from said light source and corresponds to a periphery of said light beam, and a second optical element for converting a direction of polarization of the light obtainable in a location that permits passage of the diffracted light beam.

17. The optical pickup apparatus according to claim 16, wherein said first optical element is in the form of a grating, and said second optical element converts the direction of polarization of said diffracted light into a direction orthogonal to a direction of polarization of light free from diffraction.

18. The optical pickup apparatus according to claim 16, wherein said first optical element is formed as an integral unit of said second optical element.

19. An optical disk apparatus comprising:
an optical pickup unit having a light source for generating light irradiated to an optical recording medium configured as a disk, a beam splitting unit for splitting a light beam emitted from said light source into a main beam and sub beams, and a photo-detecting unit for sensing said main and said sub beams reflected from a recording surface of said recording medium, followed by outputting a signal corresponding to the sensed light beams; and
a control unit for providing servo control of said optical pickup unit;
wherein said beam splitting unit generates, by deflecting a portion of the light in contained in the light beam emitted from said light source traveling toward an outside of an aperture of an objective lens for converging the light beam on the recording surface of said recording medium so as to provide passage of the light through an inside of the aperture of said objective lens, two sub beams containing, in the sub beams reflected from the recording surface of said recording medium, no area involving overlap of zero- and ±first-order light yielded by a track structure of said disk, while generating, based on the other portion of the light beam emitted from said light source, the main beam containing, in the main beam reflected from the recording surface of said recording medium, the area involving the zero- and the ±first-order light yielded by the track structure of said disk; and
said control unit generates a push-pull signal from a signal outputted from said photo-detecting unit and corresponding to a light spot of the sensed main beam, while generating a lens shift signal from a signal outputted from said photo-detecting unit and corresponding to light spots of said sensed two sub beams, followed by generating a tracking error signal based on said push-pull signal and said lens shift signal.
